(19) United States
(12) Patent Application Publication
(10) Pub. No.: US 2026/0046848 A1
(43) Pub. Date: Feb. 12, 2026

(54) CONFIGURED GRANT (CG) TRANSMISSION USING NON-CONTIGUOUS SUB-BANDS

(71) Applicant: QUALCOMM Incorporated, San Diego, CA (US)

(72) Inventors: Jing Lei, San Diego, CA (US); Yi Huang, San Diego, CA (US); Jing Sun, San Diego, CA (US)

(21) Appl. No.: 18/798,453

(22) Filed: Aug. 8, 2024

(51) Int. Cl. H04W 72/0453; H04W 72/0446

(52) U.S. Cl. CPC H04W 72/0453; H04W 72/0446

(57) ABSTRACT

An apparatus for wireless communication by a user equipment (UE) includes one or more processors, memory coupled with the one or more processors, and instructions stored in the memory. The instructions are executable by the one or more processors, individually or collectively, to cause the apparatus to receive a downlink message indicating a configured grant (CG) configuration and to perform a transmission in accordance with the CG configuration and using multiple sub-bands. The multiple sub-bands include a first sub-band and a second sub-band that is distinct from the first sub-band. The first sub-band includes a first set of frequency resources that is non-contiguous with a second set of frequency resources of the second sub-band.

### TECHNICAL FIELD

Aspects of the present disclosure relate generally to wireless communication systems, and more particularly, to transmissions within a wireless communication system, such as transmissions using a configured grant (CG).

### DESCRIPTION OF THE RELATED TECHNOLOGY

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

To further illustrate, a variety of different applications exist and are being developed for wireless communication systems. Such applications may include extended reality (XR) applications, virtual reality (VR) applications, augmented reality (AR) applications, and other applications. Some such applications may involve communication of traffic with different quality of service (QoS) requirements, which may be referred to as multimodal traffic. Coordination of traffic with different QOS requirements may be challenging and may in some cases result in dropped communications, poor resource utilization efficiency, or both. As a result, performance associated with multimodal traffic may be poor in some circumstances.

### SUMMARY

In some aspects, an apparatus for wireless communication by a user equipment (UE) includes one or more processors, memory coupled with the one or more processors, and instructions stored in the memory. The instructions are executable by the one or more processors, individually or collectively, to cause the apparatus to receive a downlink message indicating a configured grant (CG) configuration and to perform a transmission in accordance with the CG configuration and using multiple sub-bands. The multiple sub-bands include a first sub-band and a second sub-band that is distinct from the first sub-band. The first sub-band includes a first set of frequency resources that is non-contiguous with a second set of frequency resources of the second sub-band.

In some additional aspects, a method of wireless communication performed by a UE includes receiving a downlink message indicating a CG configuration. The method further includes performing a transmission in accordance with the CG configuration and using multiple sub-bands including a first sub-band and a second sub-band that is distinct from the first sub-band. The first sub-band includes a first set of frequency resources that is non-contiguous with a second set of frequency resources of the second sub-band.

In some additional aspects, an apparatus for wireless communication by a network node includes one or more processors, memory coupled with the one or more processors, and instructions stored in the memory. The instructions are executable by the one or more processors, individually or collectively, to cause the apparatus to transmit a downlink message indicating a CG configuration and to receive a transmission in accordance with the CG configuration and using multiple sub-bands. The multiple sub-bands include a first sub-band and a second sub-band that is distinct from the first sub-band. The first sub-band includes a first set of frequency resources that is non-contiguous with a second set of frequency resources of the second sub-band.

In some additional aspects, a method of wireless communication performed by a network node includes transmitting a downlink message indicating a CG configuration. The method further includes receiving a transmission in accordance with the CG configuration and using multiple sub-bands including a first sub-band and a second sub-band that is distinct from the first sub-band. The first sub-band includes a first set of frequency resources that is non-contiguous with a second set of frequency resources of the second sub-band.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system according to one or more aspects.

FIG. 4 is a diagram illustrating features that may be associated with an example of a transmission according to one or more aspects.

FIG. 5 is a diagram illustrating examples of downlink and uplink (D/U) resource allocations according to one or more aspects.

FIG. 6 is a diagram illustrating additional features that may be associated with an example of a transmission according to one or more aspects.

FIG. 7 is a diagram illustrating additional features that may be associated with an example of a transmission according to one or more aspects.

FIG. 8 is a diagram illustrating further examples that may be associated with a transmission according to one or more aspects.

FIG. 9 is a diagram illustrating examples associated with a CG configuration across multiple sub-bands according to one or more aspects.

FIG. 10 is a flow diagram illustrating an example method according to one or more aspects.

FIG. 11 is a flow diagram illustrating another example method according to one or more aspects.

FIG. 12 is a block diagram of an example UE according to one or more aspects.

FIG. 13 is a block diagram of an example network node according to one or more aspects.

Like reference numbers and designations in the various drawings indicate like elements.

### DETAILED DESCRIPTION

In some aspects of the disclosure, a wireless communication system may operate using a virtual cell that includes non-contiguous sub-bands. The wireless communication system may provide a user equipment (UE) with a configured grant (CG) configuration that uses (e.g., spans) the non-contiguous sub-bands. By using non-contiguous sub-bands in connection with one CG configuration, performance may be improved as compared to other wireless communication systems that require a CG configuration to use contiguous sub-bands or contiguous component carriers (CCs).

To illustrate, some applications (such as multimodal applications) may involve first transmissions associated with a first sub-band and second transmissions associated with a second sub-band that is non-contiguous to the first sub-band. If the first sub-band is associated with a relatively low power headroom, some wireless communication protocols may specify that the first transmissions are to be dropped in favor of the second transmissions. Further, such wireless communication protocols may disallow the second transmissions from using wireless resources of the first sub-band after dropping of the first transmissions, resulting in poor resource utilization efficiency and increased latency. By enabling a CG configuration to utilize (e.g., span) both the first sub-band and the second sub-band, such resources may be used for the first transmission. As a result, resource utilization efficiency may be increased, and latency may be decreased.

As another example, in some circumstances, some wireless communication systems may experience poor performance if transmissions are performed using certain wireless resources more often than other wireless resources, which may result in unfavorable load balancing or other characteristics. For example, a lower-frequency sub-band may experience less path loss and fading as compared to a higher-frequency sub-band and may therefore be scheduled more frequently than the higher-frequency sub-band. By enabling a CG configuration to utilize (e.g., span) both the lower-frequency sub-band and the higher-frequency sub-band, load balancing may be enhanced while also reducing performance losses associated with congestion or collisions (e.g., congestion or collisions due to a greater quantity of traffic being concentrated within the lower-frequency sub-band).

To further illustrate, one or more features described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

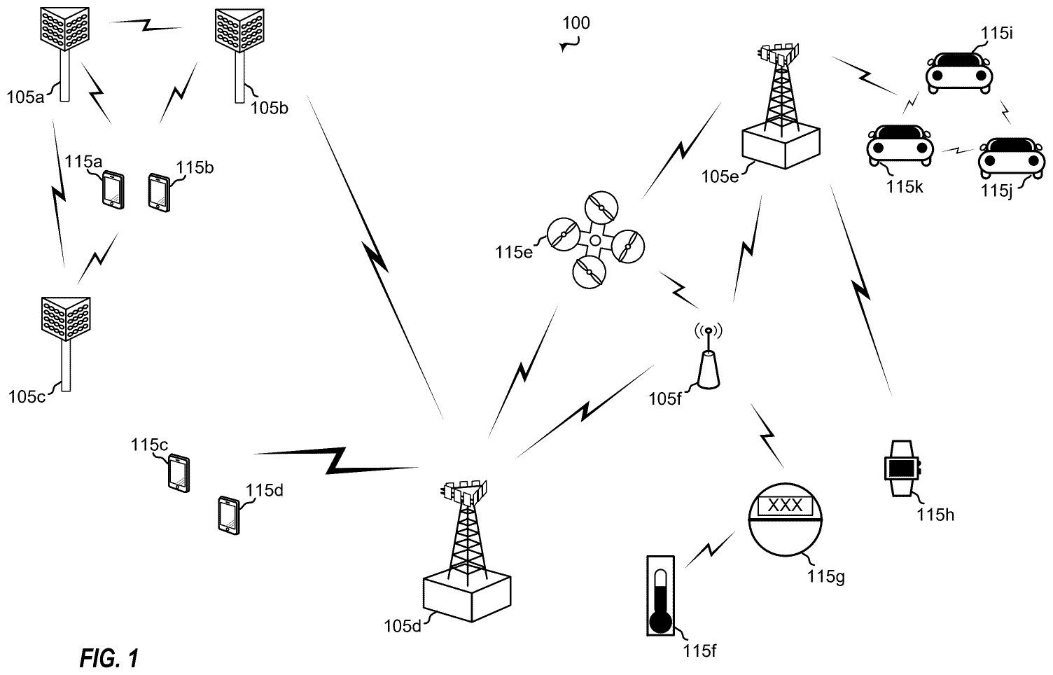

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

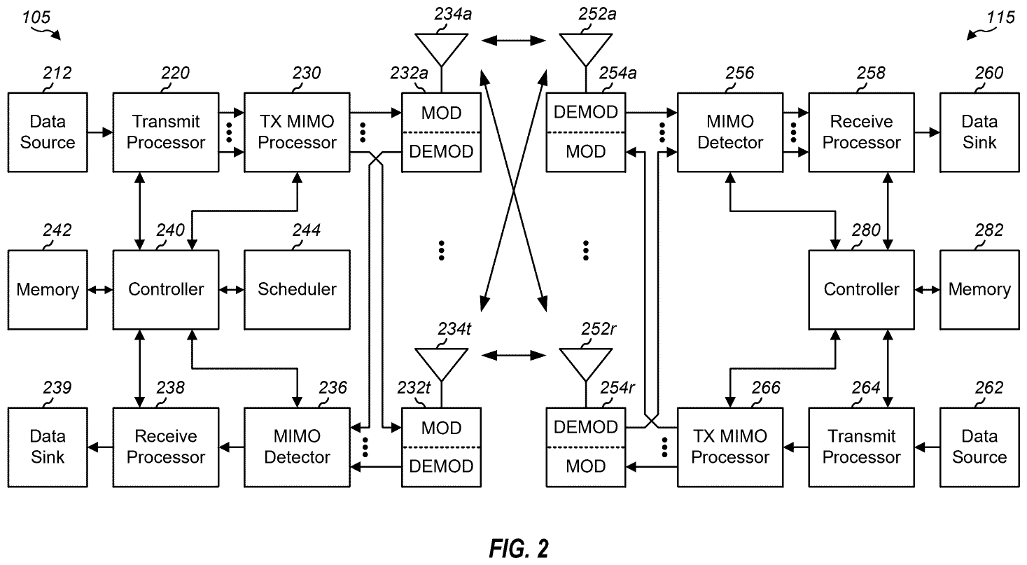

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc.

The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct one or more processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

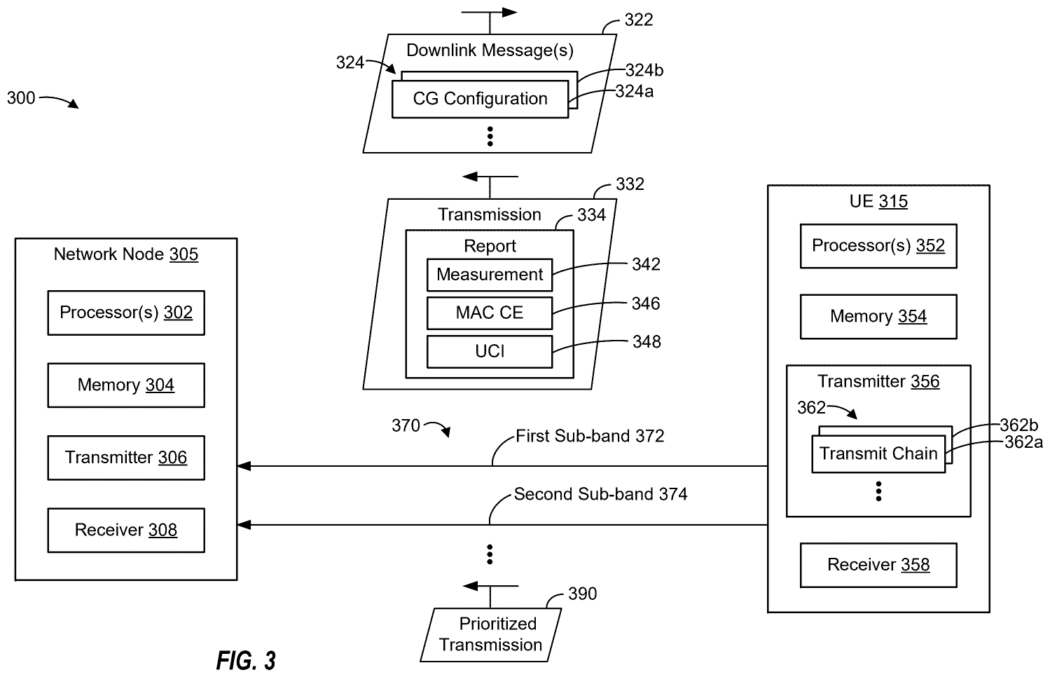

FIG. 3 is a block diagram illustrating an example wireless communication system 300 according to one or more aspects. The wireless communication system 300 may include one or more UEs, such as a UE 315. In some examples, the UE 315 may correspond to the UE 115. The wireless communication system 300 may also include one or more network nodes, such as a network node 305. In some examples, the network node 305 may correspond to the base station 105. To further illustrate, the network node 305 may include or may be implemented using one or more of a base station, a network controller, an integrated access and backhauling (IAB) node, a distributed unit (DU), a central unit (CU), or a remote/radio unit (RU) (which may also be referred to as a remote radio unit (RRU)), as illustrative examples.

In some implementations, the wireless communication system 300 may include one or more network nodes (such as the network node 305) that support a virtual cell 370. As referred to herein, a virtual cell may correspond to a logical network that includes non-contiguous frequency resources. To illustrate, the network node 305 may support communication with the UE 315 using a first sub-band 372 and a second sub-band 374, where the frequency resources of the first sub-band 372 are non-contiguous with respect to the frequency resources of the second sub-band 374.

The network node 305 may include one or more processors 302 (such as the controller 240), a memory 304 (such as the memory 242), a transmitter 306, and a receiver 308. The one or more processors 302 may be coupled to the memory 304, to the transmitter 306, and to the receiver 308. In some examples, the transmitter 306 and the receiver 308 may include one or more components described with reference to FIG. 2, such as one or more of the modulator/demodulators 232a-t, the MIMO detector 236, the receive processor 238, the transmit processor 220, or the TX MIMO processor 230. In some examples, the one or more processors 302 may be configured to individually or collectively perform one or more operations described herein.

The transmitter 306 may transmit reference signals, synchronization signals, control information, and data to one or more other devices, and the receiver 308 may receive reference signals, control information, and data from one or more other devices. For example, in some implementations, the transmitter 306 may transmit signaling, control information, and data to the UE 315, and the receiver 308 may receive signaling, control information, and data from the UE 315.

The UE 315 may include one or more processors 352 (such as the controller 280), a memory 354 (such as the memory 282), a transmitter 356, and a receiver 358. The one or more processors 352 may be coupled to the memory 354, to the transmitter 356, and to the receiver 358. In some examples, the transmitter 356 and the receiver 358 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356 and the receiver 358 may be integrated in one or more transceivers of the UE 315. In some examples, the one or more processors 352 may be configured to individually or collectively perform one or more operations described herein.

The transmitter 356 may transmit reference signals, synchronization signals, control information, and data to one or more other devices, and the receiver 358 may receive reference signals, control information, and data from one or more other devices. For example, in some implementations, the transmitter 356 may transmit signaling, control information, and data to the network node 305, and the receiver 358 may receive signaling, control information, and data from the network node 305.

The wireless communication system 300 may use wireless communication channels, which may be specified by one or more wireless communication protocols, such as a 5G NR wireless communication protocol. To illustrate, the network node 305 may communicate with the UE 315 using one or more downlink wireless communication channels (such as via one or more of a PDSCH or a PDCCH). The UE 315 may communicate with the network node 305 using one or more uplink wireless communication channels (such as via one or more of a PUSCH or a PUCCH). Alternatively, or in addition, the UE 315 may communicate with one or more other UEs, such as via a sidelink wireless communication channel.

During operation, the UE 315 may receive one or more downlink messages 322, such as downlink control information (DCI). The one or more downlink messages may indicate one or more configured grant (CG) configurations 324 for the UE 315, such as one or more of a first CG configuration 324a or a second CG configuration 324b. In some examples, the UE 315 may receive the first CG configuration 324a via one downlink message 322 and may receive the second CG configuration 324b via another downlink message 322. In some other examples, the UE 315 may receive the CG configurations 324a-b via the same downlink message 322.

The one or more CG configurations 324 may be associated with multiple sub-bands of the virtual cell 370. For example, the one or more CG configurations 324 may be associated with the first sub-band 372 and the second sub-band 374. In some examples, the first CG configuration 324a may be associated with the first sub-band 372, and the second CG configuration 324b may be associated with the second sub-band 374. In some such examples, the first CG configuration 324a may indicate that the first sub-band 372 is available to the UE 315 for uplink communications with the network node 305, and the second CG configuration 324b may indicate that the second sub-band 374 is available to the UE 315 for uplink communications with the network node 305.

The UE 315 may perform one or more transmissions in accordance with any of the one or more CG configurations 324. For example, the UE 315 may perform a transmission 332 (e.g., a CG transmission) in accordance with one or more of the CG configurations 324a-b. In an example, the UE 315 may perform the transmission 332 using the first sub-band and the second sub-band 374. In some examples, the transmission 332 may include an uplink transmission, such as a physical uplink shared channel (PUSCH) transmission or a physical uplink control channel (PUCCH) transmission. In such examples, the first sub-band 372 and the second sub-band 374 may correspond to uplink sub-bands. Other examples are also within the scope of the disclosure. For example, one or more aspects described herein may be used in connection with a downlink transmission performed the network node 305 or a sidelink transmission performed or received by the UE 315. In some such examples, the first sub-band 372 and the second sub-band 374 may correspond to downlink sub-bands or sidelink sub-bands.

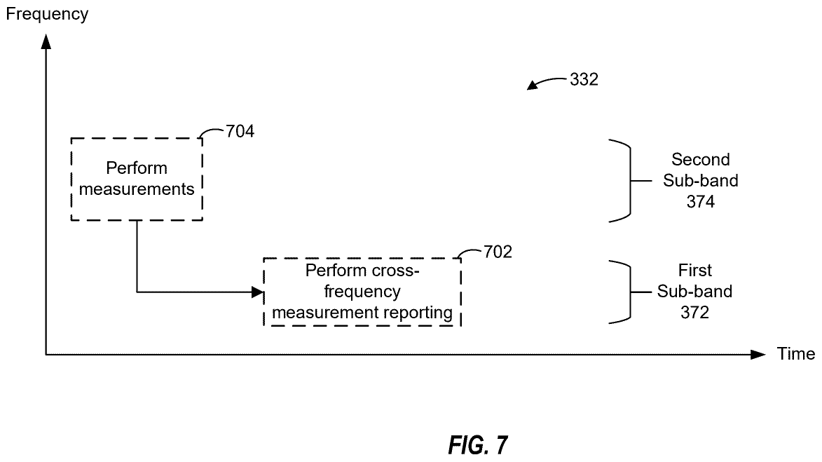

In some examples, the transmission 332 may include or may correspond to a cross-frequency transmission. In some such examples, the UE 315 may perform the transmission 332 via one of the first sub-band 372 or the second sub-band 374, and the transmission 332 may include data or information associated with the other of the first sub-band 372 or the second sub-band 374. To illustrate, performing the transmission 332 may include transmitting, via the first sub-band 372, a report 334 associated with the second sub-band 374. In some examples, the report 334 may correspond to a measurement report, a power headroom report (PHR), or another report. To further illustrate, in some examples, the report 334 may indicate one or more of a measurement 342 associated with the second sub-band, a medium access control (MAC) control element (MAC CE) 346 associated with the second sub-band, or uplink control information (UCI) 348 associated with the second sub-band. Alternatively, or in addition, the report 334 may include a layer one (L1) report, a layer two (L2) report, a layer three (L3) report, a buffer status report (BSR), a scheduling request (SR), channel state information (CSI), a channel quality indicator (CQI), or an unused transmission occasion (UTO) indicator, as illustrative examples. In some examples, the UE 315 may report the measurement 342 periodically or non-periodically. Some illustrative examples that may be associated with a cross-frequency transmission are described further with reference to FIG. 7.342

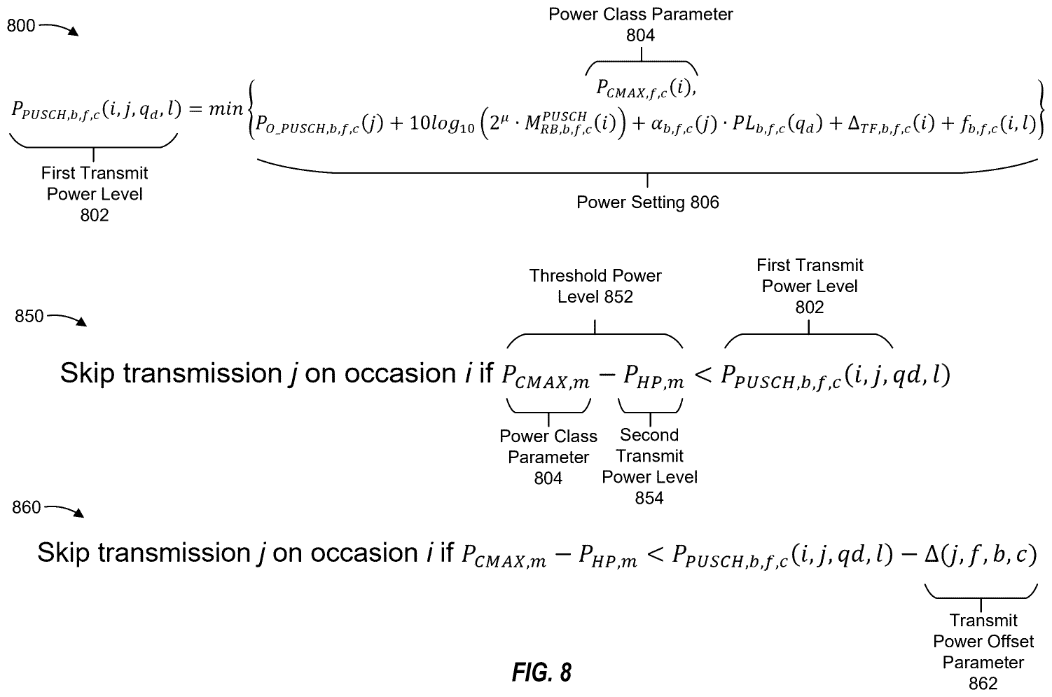

In some examples, the UE 315 may detect a conflict between multiple transmissions, such as transmissions that are to be performed by the UE 315 to the network node 305. To illustrate, the UE 315 may detect a conflict between the transmission 332 and a second transmission, such as a prioritized transmission 390 that may be associated with a greater priority than the transmission 390. For example, the transmitter 356 of the UE 315 may include one or more transmit chains 362 (such as a transmit chain 362a and a transmit chain 362b), and the transmission 332 and the prioritized transmission 390 may be scheduled to use the same transmit chain 362. In some examples, the UE 315 may skip one or more occasions associated with the transmission 332 based on the conflict (e.g., to deprioritize the transmission 332 as compared to the prioritized transmission 390). Some illustrative examples of prioritization of transmissions are described further with reference to FIG. 8.

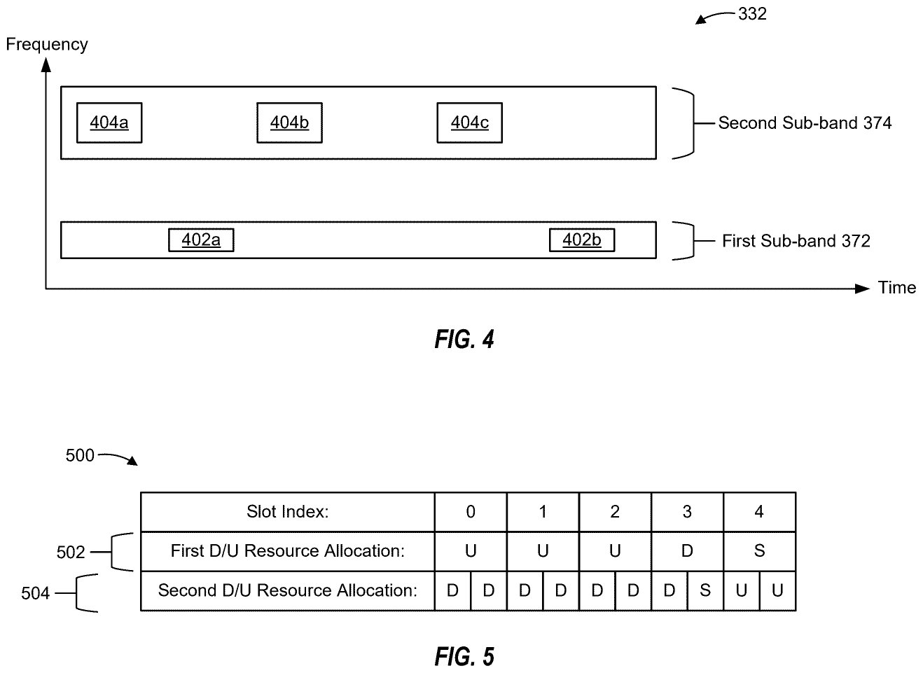

FIG. 4 is a diagram illustrating features that may be associated with an example of the transmission 332 of FIG. 3 according to one or more aspects. The transmission 332 may be performed using the first sub-band 372 and the second sub-band 374. In the example of FIG. 4, the first sub-band 372 includes a first set of frequency resources that is non-contiguous with a second set of frequency resources of the second sub-band 374.

FIG. 4 also illustrates that the transmission 332 may be performed using at least a first occasion associated with the first sub-band 372 and using at least a second occasion associated with the second sub-band 374. For example, the first occasion may correspond to any of occasions 402a and 402b, and the second occasion may correspond to any of occasions 404a, 404b, and 404c. As a result, data throughput may be increased by selecting occasions associated with both the first sub-band 372 and the second sub-band 374 (as compared to selecting occasions associated with only one of the first sub-band 372 or the second sub-band 374).

FIG. 5 is a diagram illustrating examples of downlink and uplink (D/U) resource allocations 500 according to one or more aspects. The D/U resource allocations 500 may include a first D/U resource allocation 502 and a second D/U resource allocation 504 for time slots 0, 1, 2, 3, and 4. In some examples, the first D/U resource allocation 502 may be associated with the first sub-band 372, and the second D/U resource allocation 504 may be associated with the second sub-band 374. For example, the first D/U resource allocation 502 and the second D/U resource allocation 504 may be specified by the one or more CG configurations 324 of FIG. 3.

During time slots 0, 1, and 2, the first D/U resource allocation 502 may be associated with uplink resources (“U”). During time slots 0, 1, and 2, the second D/U resource allocation 504 may be associated with sub-slots associated with downlink resources (“D”). During time slot 3, the first D/U resource allocation may be associated with downlink resources. During time slot 4, the second D/U resource allocation may be associated with uplink resources. In the example of FIG. 5, “S” may indicate a switching slot (or a switching sub-slot). In some examples, a switching slot (or a switching sub-slot) may enable switching from downlink operation to uplink operation (e.g., to accommodate a retuning gap from downlink operation to uplink operation).

In some examples, to perform the transmission 332, the UE 315 may select one or more first uplink resources from the first D/U resource allocation 502 and may select one or more second uplink resources from the second D/U resource allocation 504. For example, the one or more first uplink resources may include uplink resources of time slots 0, 1, and 2 of the first D/U resource allocation 502, and the one or more second uplink resources may include uplink resources of time slot 4 for the second D/U uplink resource allocation 504. The UE 315 may perform the transmission 332 in accordance with the one or more first uplink resources and the one or more second uplink resources. As a result, data throughput may be increased by selecting resources from both the first D/U resource allocation 502 and the second D/U resource allocation 504 (as compared to using resources of only one of the first D/U resource allocation 502 or the second D/U resource allocation 504).

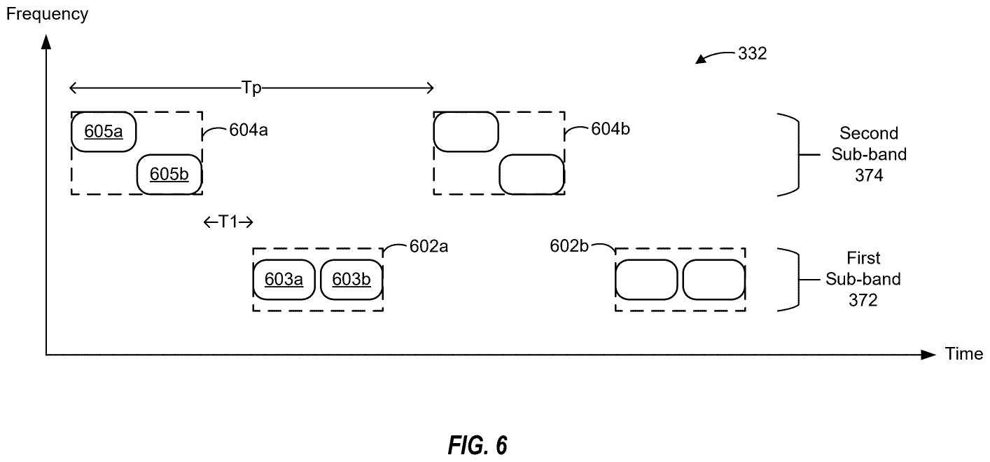

FIG. 6 is a diagram illustrating additional features that may be associated with an example of the transmission 332 of FIG. 3 according to one or more aspects. The transmission 332 may be performed using the first sub-band 372 and the second sub-band 374. In the example of FIG. 6, the first sub-band 372 includes a first set of frequency resources that is non-contiguous with a second set of frequency resources of the second sub-band 374.

The first sub-band 372 may be associated with an occasion 602a and an occasion 602b. The second sub-band 374 may be associated with an occasion 604a and an occasion 604b. In some examples, occasions of the first sub-band 372 may be separated from occasions of the second sub-band 374 based on a time offset T1. For example, a beginning of the occasion 602a may occur after a time offset T1 following an end of the occasion 604a.

In some examples, at least one of the first sub-band 372 or the second sub-band 374 may be associated with a particular period. Within the particular period, the first sub-band 372 may be associated with a first resource configuration and the second sub-band 374 may be associated with a second resource configuration different than the first configuration. In some examples, the first resource configuration may include one of a frequency hopping configuration or a time repetition configuration, and the second resource configuration may include the other of the frequency hopping configuration or the time repetition configuration.

To illustrate, the particular period may correspond to a period Tp. Within a period Tp, the first sub-band 372 may be associated with a time repetition configuration (e.g., where the occasion 602a includes repetitions 603a and 603b), and the second sub-band 374 may be associated with a frequency hopping configuration (e.g., where the occasion 604a is associated with frequency hopping transmissions 605a and 605b). As a result, in some examples, the transmission 332 may use multiple different resource configurations associated with different sub-bands, which may increase transmission scheme diversity associated with the transmission 332.

FIG. 7 is a diagram illustrating additional features that may be associated with an example of the transmission 332 of FIG. 3 according to one or more aspects. The transmission 332 may be performed using the first sub-band 372 and the second sub-band 374. In the example of FIG. 6, the first sub-band 372 includes a first set of frequency resources that is non-contiguous with a second set of frequency resources of the second sub-band 374.

In the example of FIG. 7, the UE 315 may perform measurements associated with the second sub-band 374 during an occasion 704 associated with the second sub-band 374. To illustrate, in some examples, the UE 315 may perform the measurement 342 of FIG. 3 during the occasion 704. The UE 315 may perform cross-frequency measurement reporting via the first sub-band 372 during an occasion 702 associated with the first sub-band 372, such as by transmitting the report 334.

FIG. 8 is a diagram illustrating further examples that may be associated with a transmission, such as the transmission 332 of FIG. 3, according to one or more aspects. The example of FIG. 8 illustrates a process 800 for determining a first transmit power level 802 for the transmission 332. In the example of FIG. 8, the first transmit power level 802 may be indicated as P_{PUSCH,b,f,c}(i,j,q_{d},l). In this example, the transmission 332 may correspond to a PUSCH transmission. Other examples are also with the scope of the disclosure, such as where the transmission 332 may correspond to a PUCCH transmission or a sidelink transmission, as illustrative examples. In some examples, one or more parameters described with reference to FIG. 8 may be expressed in decibel-milliwatts (dBm).

To further illustrate, in some examples, b may indicate an active bandwidth part (BWP) that includes a particular sub-band f (such as one or more of the sub-bands 372, 374), c may indicate a serving cell (such as the network node 305), i may indicate a particular CG occasion associated with the sub-band f (such as any of the occasions 402a-b, 404a-c, 602-a-b, 604a-b, 702, or 704), j may indicate a CG configuration (such as the first CG configuration 324a or the second CG configuration 324b), q_{d} may indicate an index value associated with a reference signal configured for pathloss estimation, and/may indicate a closed loop power control (CLPC) adjustment state (such as the most recent CLPC adjustment state used by the UE 315). Further, P0 may indicate the target receiver power (e.g., a target power level of the receiver 358), M may indicate a quantity of resource blocks (RBs) for resource allocation (which may be associated with a PUSCH transmission), a may indicate a pathloss exponent, and TF may indicate a transport format.

The process 800 may include selecting the lesser (“min”) of a power class parameter 804 (P_{CMAX}) or a power setting 806. In the power setting 806, PL may indicate a path loss characteristic, and A may indicate a transmit power offset value (e.g., where Δ>0) that may be associated with the CG configuration j on sub-band f of BWP b. For brevity, a transmission performed in accordance with the CG configuration j may also be referred to as a transmission j.

FIG. 8 also illustrates an example of a process 850. In the process 850, the UE 315 may determine whether the first transmit power level 802 exceeds a threshold power level 852 for transmission j during the particular CG occasion i. To illustrate, the transmission j may correspond to the transmission 332 or another transmission. The threshold power level 852 may be based on the power class parameter 804 for a transmit chain m of the UE 315 and may be based further on a second transmit power level 854 (P_{HP,m}) of a second transmission that is to use the transmit chain m. In some examples, the second transmission may correspond to the prioritized transmission 390 of FIG. 3.

If the first transmit power level 802 fails to exceed the threshold power level 852, the process 850 may include performing the transmission j on the particular CG occasion i. In some other examples, if the first transmit power level 802 exceeds the threshold power level 852, the process 850 may include skipping the transmission j on the particular CG occasion i (e.g., by skipping a transmit opportunity of the transmission 332 in favor of the prioritized transmission 390). In some such examples, the process 850 may include performing the prioritized transmission 390 during the particular CG occasion i.

As illustrated in the example of the process 850 in FIG. 8, the threshold power level 852 may be determined based on the power class parameter 804 associated with the transmit chain m of the UE 315 and further based on the second transmit power level 854. For example, the threshold power level 852 may correspond to or may be based on a sum of the power class parameter 804 and the second transmit power level 854. Other examples are also within the scope of the disclosure. For example, in an example of a process 860, the threshold power level 852 may be based further on a transmit power offset parameter 862. In such examples, the threshold power level 852 may correspond to or may be based on a sum of the power class parameter 804, the second transmit power level 854, and the transmit power offset parameter 862.

Further, in some implementations, the UE 315 may transmit a message indicating one or more parameters described with reference to FIG. 8. In some examples, the message may correspond to the report 334 of FIG. 3. The message may indicate, for example, an amount of transmit power saved by the UE 315 by skipping the transmission j on the particular CG occasion i (e.g., in accordance with the process 850 or the process 860). In some examples, the UE 315 may indicate the amount of transmit power via a power headroom report (PHR) that corresponds to the report 334.

Alternatively, or in addition, the UE 315 may perform dynamic transmit power aggregation. For example, the UE 315 may apply the amount of transmit power saved by skipping the transmission j on the particular CG occasion i to one or more subsequent occasions associated with the transmission j. In such examples, a total amount of power used by or allocated to the one or more subsequent occasions may be modified (e.g., increased) in accordance with the amount of transmit power saved by skipping the transmission j on the particular CG occasion i.

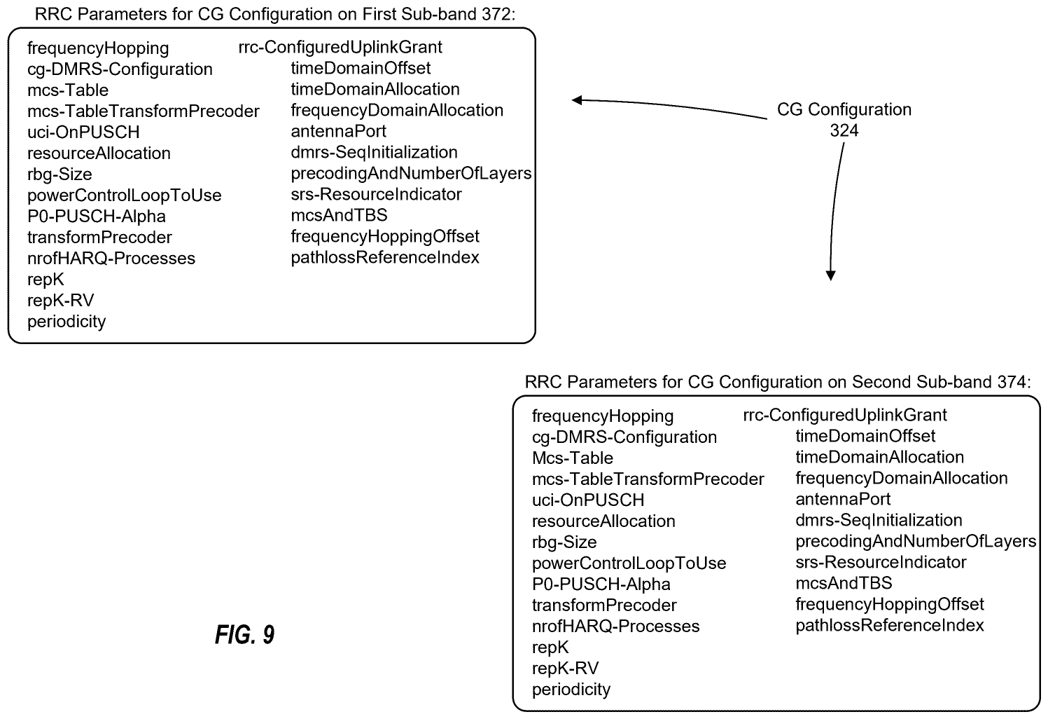

FIG. 9 is a diagram illustrating examples associated with a CG configuration 324 across multiple sub-bands, such as the first sub-band 372 and the second sub-band 374, according to one or more aspects. The CG configuration 324 may also be referred to as being configured for, or shared among, the multiple sub-bands. In the example of FIG. 9, the CG configuration 324 may specify, for one or both of the first sub-band 372 and the second sub-band 374, RRC parameters including one or more of frequencyHopping, cg-DMRS-Configuration, mcs-Table, mcs-TableTransformPrecoder, uci-OnPUSCH, resource Allocation, rbg-Size, powerControlLoopToUse, P0-PUSCH-Alpha, transformPrecoder, nrofHARQ-Processes, repK, repK-RV, periodicity, or rrc-ConfiguredUplinkGrant. In some examples, rrc-ConfiguredUplinkGrant may indicate one or more of timeDomainOffset, timeDomainAllocation, frequencyDomainAllocation, antennaPort, dmrs-SeqInitialization, precodingAndNumberOfLayers, srs-ResourceIndicator, mcsAndTBS, frequencyHoppingOffset, or pathlossReferenceIndex.

To further illustrate some aspects of the disclosure, in some implementations, radio resource allocation for a single CG configuration may be activated on multiple sub-bands of a virtual cell. In some examples, uplink (UL) medium access control (MAC) service data units (SDUs) from one or more logic channels with similar or the same quality of service (QoS) requirements may be multiplexed and mapped to a valid CG occasion, which may improve resource utilization efficiency. The RRC parameters of a CG configuration may be shared among, or separately configured for, multiple sub-bands. For example, transmit occasions for a CG configuration may be activated on two sub-bands by time division multiplexing (TDM) and frequency division multiplexing (FDM), such as illustrated in the example of FIG. 4. To reduce latency of grant-free transmissions, a D/U resource configuration may be complementary in time across different sub-bands (e.g., as described in connection with FIG. 5).

In some examples, CG occasions with different waveforms, MCS, and radio resource allocations may be configured in a CG period (e.g., Tp) associated with a CG occasion (e.g., as described with reference to FIG. 6). One or more of intra-sub-band frequency hopping or intra-sub-band repetition may be enabled on CG occasions of the CG configuration. For a UE 315 supporting multiple transmit chains (such as the transmit chains 362), CG occasions may be multiplexed across different sub-bands via FDM. For a UE 315 supporting transmit chain switching between different sub-bands, a time offset (e.g., T0) between adjacent CG occasions on different sub-bands may be lower bounded by the duration of a radio frequency (RF) retuning gap, which may depend on the UE capability of the particular UE 315.

In some examples, cross-frequency reporting may be performed. For example, if an uplink BWP or a CG configuration of the UE 315 spans multiple sub-bands, the UE 315 may be configured (e.g., by the network node 305) to report periodic or aperiodic measurements (such as the measurement 342), one or more MAC CEs, and UCI associated with one or more sub-bands. For example, the UE 315 may transmit one or more of a layer one (L1) report, a layer two (L2) report, a layer three (L3) report, a buffer status report (BSR), a scheduling request (SR), channel state information (CSI), a channel quality indicator (CQI), or an unused transmission occasion (UTO) indicator, as illustrative examples.

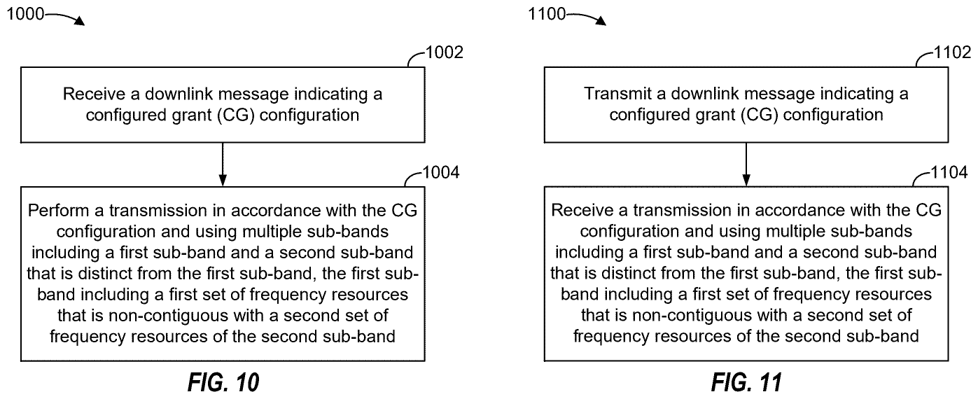

FIG. 10 is a flow diagram illustrating an example method 1000 according to one or more aspects. In some examples, the method 1000 may be performed by a UE, such as the UE 115 or the UE 315.

The method 1000 includes receiving a downlink message indicating a configured grant (CG) configuration, at 1002. For example, the UE 315 may receive any of the one or more downlink messages 322 indicating any of the one or more CG configurations 324.

The method 1000 further includes performing a transmission in accordance with the CG configuration and using multiple sub-bands including a first sub-band and a second sub-band that is distinct from the first sub-band, at 1004. The first sub-band includes a first set of frequency resources that is non-contiguous with a second set of frequency resources of the second sub-band. For example, the UE 315 may perform the transmission 332 in accordance with a CG configuration 324 and using the first sub-band 372 and the second sub-band 374.

FIG. 11 is a flow diagram illustrating an example method 1100 according to one or more aspects. In some examples, the method 1100 may be performed by a network node (e.g., a base station). For example, the method 1100 may be performed by the base station 105 or the network node 305.

The method 1100 includes transmitting a downlink message indicating a configured grant (CG) configuration, at 1102. For example, network node 305 may transmit any of the one or more downlink messages 322 indicating any of the one or more CG configurations 324.

The method 1100 further includes receiving a transmission in accordance with the CG configuration and using multiple sub-bands including a first sub-band and a second sub-band that is distinct from the first sub-band, at 1104. The first sub-band includes a first set of frequency resources that is non-contiguous with a second set of frequency resources of the second sub-band. For example, network node 305 may receive the transmission 332 in accordance with a CG configuration 324 and using the first sub-band 372 and the second sub-band 374.

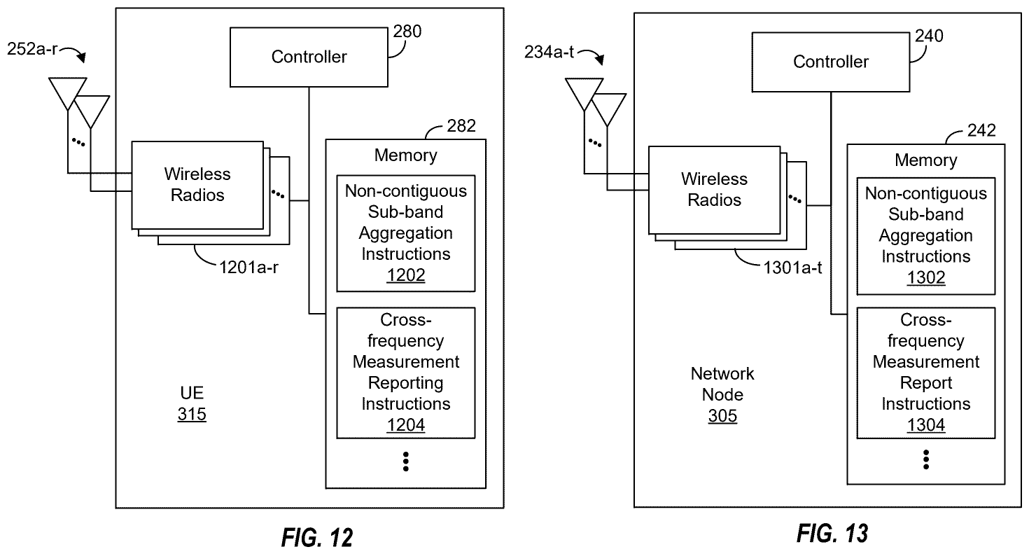

FIG. 12 is a block diagram of an example UE 315 according to one or more aspects. The UE 315 may include structure, hardware, or components illustrated in FIG. 2. For example, the UE 315 may include the controller 280, which may execute instructions stored in the memory 282. Using the controller 280, the UE 115 may transmit and receive signals via wireless radios 1201a-r and antennas 252a-r. The wireless radios 1201a-r may include one or more components or devices described herein, such as the modulator/demodulators 254a-r, the MIMO detector 256, the receive processor 258, the transmit processor 264, the TX MIMO processor 266, the transmitter 356, the receiver 358, one or more other components or devices, or a combination thereof.

In some examples, the memory 282 may store instructions executable by one or more processors (e.g., the controller 280) to initiate, perform, or control one or more operations described herein. For example, the memory 282 may store non-contiguous sub-band aggregation instructions 1202 executable by the controller 280 to cause the UE 315 to perform the transmission 332 using the first sub-band 372 and the second sub-band 374. In some examples, the non-contiguous sub-band aggregation instructions 1302 may executable by the controller 240 to identify available sub-bands from among different CG configurations 324 and to aggregate the available sub-bands for a single transmission (such as the transmission 332). The available sub-bands may include non-contiguous sub-bands, such as the first sub-band 372 and the second sub-band 374. As another example, the memory 282 may store cross-frequency measurement reporting instructions 1204 executable by the controller 280 to cause the UE 315 to perform cross-frequency measurement reporting, such as by transmitting the report 334.

FIG. 13 is a block diagram of an example network node 305 according to one or more aspects. The network node 305 may include structure, hardware, and components illustrated in FIG. 2. For example, the network node 305 may include the controller 240, which may execute instructions stored in memory 242. Under control of the controller 240, the network node 305 may transmit and receive signals via wireless radios 1301a-t and antennas 234a-t. The wireless radios 1301a-t may include one or more components or devices described herein, such as the modulator/demodulators 232a-t, the MIMO detector 236, the receive processor 238, the transmit processor 220, the TX MIMO processor 230, the transmitter 306, the receiver 308, one or more other components or devices, or a combination thereof.

In some examples, the memory 242 may store instructions executable by one or more processors (e.g., the controller 240) to initiate, perform, or control one or more operations described herein. For example, the memory 242 may store non-contiguous sub-band aggregation instructions 1302 executable by the controller 240 to cause the network node 305 to receive the transmission 332 using the first sub-band 372 and the second sub-band 374. As another example, the memory 242 may store cross-frequency measurement report instructions 1304 executable by the controller 240 to cause the network node 305 to receive cross-frequency measurement reporting, such as by receiving the report 334.

One or more features described herein may improve performance of a wireless communication system. To illustrate, some applications (such as multimodal applications) may involve first transmissions associated with a first sub-band and second transmissions associated with a second sub-band that is non-contiguous to the first sub-band. If the first sub-band is associated with a relatively low power headroom, some wireless communication protocols may specify that the first transmissions are to be dropped in favor of the second transmissions. Further, such wireless communication protocols may disallow the second transmissions from using wireless resources of the first sub-band after dropping of the first transmissions, resulting in poor resource utilization efficiency and increased latency. By enabling a CG configuration 324 to utilize (e.g., span) both the first sub-band 372 and the second sub-band 374, such resources may be used for a single transmission (e.g., the transmission 332). As a result, resource utilization efficiency may be increased, and latency may be decreased.

As another example, in some circumstances, some wireless communication systems may experience poor performance if transmissions are performed using certain wireless resources more often than other wireless resources, which may result in unfavorable load balancing or other characteristics. For example, a lower-frequency sub-band may experience less path loss and fading as compared to a higher-frequency sub-band and may therefore be scheduled more frequently than the higher-frequency sub-band. By enabling a CG configuration 324 to utilize (e.g., span) both the lower-frequency sub-band (e.g., the first sub-band 372) and the higher-frequency sub-band (e.g., the second sub-band 374), load balancing may be enhanced while also reducing performance losses associated with congestion or collisions (e.g., congestion or collisions due to a greater quantity of traffic being concentrated within the lower-frequency sub-band).

In a first aspect, an apparatus for wireless communication by a user equipment (UE) includes one or more processors, memory coupled with the one or more processors, and instructions stored in the memory. The instructions are executable by the one or more processors, individually or collectively, to cause the apparatus to receive a downlink message indicating a configured grant (CG) configuration and to perform a transmission in accordance with the CG configuration and using multiple sub-bands. The multiple sub-bands include a first sub-band and a second sub-band that is distinct from the first sub-band. The first sub-band includes a first set of frequency resources that is non-contiguous with a second set of frequency resources of the second sub-band.

In a second aspect, in combination with the first aspect, the first sub-band is associated with a first downlink and uplink (D/U) resource allocation for a plurality of time slots, the second sub-band is associated with a second D/U resource allocation for the plurality of time slots, and the second D/U resource allocation is different than the first D/U resource allocation.

In a third aspect, in combination with one or more of the first aspect or the second aspect, the instructions are further executable by the one or more processors, individually or collectively, to cause the apparatus to select one or more first uplink resources from the first D/U resource allocation, to select one or more second uplink resources from the second D/U resource allocation, and to perform the transmission further in accordance with the one or more first uplink resources and the one or more second uplink resources.

In a fourth aspect, in combination with one or more of the first aspect through the third aspect, the instructions are further executable by the one or more processors, individually or collectively, to cause the apparatus to perform the transmission using at least a first occasion associated with the first sub-band and using at least a second occasion associated with the second sub-band.

In a fifth aspect, in combination with one or more of the first aspect through the fourth aspect, at least one of the first sub-band or the second sub-band is associated with a particular period, and, within the particular period, the first sub-band is associated with a first resource configuration and the second sub-band is associated with a second resource configuration different than the first configuration.

In a sixth aspect, in combination with one or more of the first aspect through the fifth aspect, the first resource configuration includes one of a frequency hopping configuration or a time repetition configuration, and the second resource configuration includes the other of the frequency hopping configuration or the time repetition configuration.

In a seventh aspect, in combination with one or more of the first aspect through the sixth aspect, the instructions are further executable by the one or more processors, individually or collectively, to cause the apparatus to transmit, in connection with the transmission and via the first sub-band, a report associated with the second sub-band.

In an eighth aspect, in combination with one or more of the first aspect through the seventh aspect, the report indicates one or more of a measurement associated with the second sub-band, a medium access control (MAC) control element (MAC CE) associated with the second sub-band, or uplink control information (UCI) associated with the second sub-band.

In a ninth aspect, in combination with one or more of the first aspect through the eighth aspect, the instructions are further executable by the one or more processors, individually or collectively, to cause the apparatus, in accordance with determining that a first transmit power level associated with a particular CG occasion associated with the transmission exceeds a threshold power level, to skip a transmit opportunity of the transmission during the particular CG occasion and to perform a second transmission during the particular CG occasion. The second transmission has a greater priority than the transmission.

In a tenth aspect, in combination with one or more of the first aspect through the ninth aspect, the instructions are further executable by the one or more processors, individually or collectively, to cause the apparatus to determine the threshold power level in accordance with a power class parameter associated with a transmit chain of the UE and further in accordance with a second transmit power level associated with the second transmission.

In an eleventh aspect, in combination with one or more of the first aspect through the tenth aspect, the instructions are further executable by the one or more processors, individually or collectively, to cause the apparatus to determine the threshold power level in accordance with a power class parameter associated with a transmit chain of the UE, a second transmit power level associated with the second transmission, and a transmit power offset parameter associated with the CG configuration.

In a twelfth aspect, in combination with one or more of the first aspect through the eleventh aspect, the multiple sub-bands are associated with a virtual cell.

In a thirteenth aspect, a method of wireless communication performed by a user equipment (UE) includes receiving a downlink message indicating a configured grant (CG) configuration. The method further includes performing a transmission in accordance with the CG configuration and using multiple sub-bands including a first sub-band and a second sub-band that is distinct from the first sub-band. The first sub-band includes a first set of frequency resources that is non-contiguous with a second set of frequency resources of the second sub-band.

In a fourteenth aspect, in combination with the thirteenth aspect, the first sub-band is associated with a first downlink and uplink (D/U) resource allocation for a plurality of time slots, the second sub-band is associated with a second D/U resource allocation for the plurality of time slots, and the second D/U resource allocation is different than the first D/U resource allocation.

In a fifteenth aspect, in combination with one or more of the thirteenth aspect through the fourteenth aspect, the method further includes selecting one or more first uplink resources from the first D/U resource allocation and selecting one or more second uplink resources from the second D/U resource allocation. The transmission is performed further in accordance with the one or more first uplink resources and the one or more second uplink resources.

In a sixteenth aspect, in combination with one or more of the thirteenth aspect through the fifteenth aspect, the transmission is performed using at least a first occasion associated with the first sub-band and using at least a second occasion associated with the second sub-band.

In a seventeenth aspect, in combination with one or more of the thirteenth aspect through the sixteenth aspect, at least one of the first sub-band or the second sub-band is associated with a particular period, and, within the particular period, the first sub-band is associated with a first resource configuration and the second sub-band is associated with a second resource configuration different than the first configuration.

In an eighteenth aspect, in combination with one or more of the thirteenth aspect through the seventeenth aspect, the first resource configuration includes one of a frequency hopping configuration or a time repetition configuration, and the second resource configuration includes the other of the frequency hopping configuration or the time repetition configuration.

In a nineteenth aspect, in combination with one or more of the thirteenth aspect through the eighteenth aspect, performing the transmission includes transmitting, via the first sub-band, a report associated with the second sub-band.

In a twentieth aspect, in combination with one or more of the thirteenth aspect through the nineteenth aspect, the report indicates one or more of a measurement associated with the second sub-band, a medium access control (MAC) control element (MAC CE) associated with the second sub-band, or uplink control information (UCI) associated with the second sub-band.

In a twenty-first aspect, in combination with one or more of the thirteenth aspect through the twentieth aspect, the method further includes, in accordance with determining that a first transmit power level associated with a particular CG occasion associated with the transmission exceeds a threshold power level, skipping a transmit opportunity of the transmission during the particular CG occasion and performing a second transmission during the particular CG occasion. The second transmission has a greater priority than the transmission.

In a twenty-second aspect, in combination with one or more of the thirteenth aspect through the twenty-first aspect, the threshold power level is determined in accordance with a power class parameter associated with a transmit chain of the UE and further in accordance with a second transmit power level associated with the second transmission.

In a twenty-third aspect, in combination with one or more of the thirteenth aspect through the twenty-second aspect, the threshold power level is determined in accordance with a power class parameter associated with a transmit chain of the UE, a second transmit power level associated with the second transmission, and a transmit power offset parameter associated with the CG configuration.

In a twenty-fourth aspect, in combination with one or more of the thirteenth aspect through the twenty-third aspect, the multiple sub-bands are associated with a virtual cell.

In a twenty-fifth aspect, an apparatus for wireless communication by a network node includes one or more processors, memory coupled with the one or more processors, and instructions stored in the memory. The instructions are executable by the one or more processors, individually or collectively, to cause the apparatus to transmit a downlink message indicating a configured grant (CG) configuration and to receive a transmission in accordance with the CG configuration and using multiple sub-bands. The multiple sub-bands include a first sub-band and a second sub-band that is distinct from the first sub-band. The first sub-band includes a first set of frequency resources that is non-contiguous with a second set of frequency resources of the second sub-band.

In a twenty-sixth aspect, in combination with the twenty-fifth aspect, the instructions are further executable by the one or more processors, individually or collectively, to cause the apparatus to receive, in connection with the transmission and via the first sub-band, a report associated with the second sub-band.

In a twenty-seventh aspect, in combination with one or more of the twenty-fifth aspect through the twenty-sixth aspect, the report indicates one or more of a measurement associated with the second sub-band, a medium access control (MAC) control element (MAC CE) associated with the second sub-band, or uplink control information (UCI) associated with the second sub-band.

In a twenty-eighth aspect, a method of wireless communication performed by a network node includes transmitting a downlink message indicating a configured grant (CG) configuration. The method further includes receiving a transmission in accordance with the CG configuration and using multiple sub-bands including a first sub-band and a second sub-band that is distinct from the first sub-band. The first sub-band includes a first set of frequency resources that is non-contiguous with a second set of frequency resources of the second sub-band.

In a twenty-ninth aspect, in combination with the twenty-eighth aspect, receiving the transmission includes receiving, via the first sub-band, a report associated with the second sub-band.

In a thirtieth aspect, in combination with one or more of the twenty-eighth aspect through the twenty-ninth aspect, the report indicates one or more of a measurement associated with the second sub-band, a medium access control (MAC) control element (MAC CE) associated with the second sub-band, or uplink control information (UCI) associated with the second sub-band.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), comprising:
one or more processors;
memory coupled with the one or more processors; and
instructions stored in the memory and executable by the one or more processors, individually or collectively, to cause the apparatus to:
receive a downlink message indicating a configured grant (CG) configuration; and
perform a transmission in accordance with the CG configuration and using multiple sub-bands including a first sub-band and a second sub-band that is distinct from the first sub-band, the first sub-band including a first set of frequency resources that is non-contiguous with a second set of frequency resources of the second sub-band.

2. The apparatus of claim 1, wherein the first sub-band is associated with a first downlink and uplink (D/U) resource allocation for a plurality of time slots, wherein the second sub-band is associated with a second D/U resource allocation for the plurality of time slots, and wherein the second D/U resource allocation is different than the first D/U resource allocation.

3. The apparatus of claim 2, wherein the instructions are further executable by the one or more processors, individually or collectively, to cause the apparatus to:
select one or more first uplink resources from the first D/U resource allocation;
select one or more second uplink resources from the second D/U resource allocation; and
perform the transmission further in accordance with the one or more first uplink resources and the one or more second uplink resources.

4. The apparatus of claim 1, wherein the instructions are further executable by the one or more processors, individually or collectively, to cause the apparatus to perform the transmission using at least a first occasion associated with the first sub-band and using at least a second occasion associated with the second sub-band.

5. The apparatus of claim 1, wherein at least one of the first sub-band or the second sub-band is associated with a particular period, and wherein, within the particular period, the first sub-band is associated with a first resource configuration and the second sub-band is associated with a second resource configuration different than the first configuration.

6. The apparatus of claim 5, wherein the first resource configuration includes one of a frequency hopping configuration or a time repetition configuration, and wherein the second resource configuration includes the other of the frequency hopping configuration or the time repetition configuration.

7. The apparatus of claim 1, wherein the instructions are further executable by the one or more processors, individually or collectively, to cause the apparatus to transmit, in connection with the transmission and via the first sub-band, a report associated with the second sub-band.

8. The apparatus of claim 7, wherein the report indicates one or more of a measurement associated with the second sub-band, a medium access control (MAC) control element (MAC CE) associated with the second sub-band, or uplink control information (UCI) associated with the second sub-band.

9. The apparatus of claim 1, wherein the instructions are further executable by the one or more processors, individually or collectively, to cause the apparatus to:
in accordance with determining that a first transmit power level associated with a particular CG occasion associated with the transmission exceeds a threshold power level:
skip a transmit opportunity of the transmission during the particular CG occasion; and
perform a second transmission during the particular CG occasion, the second transmission having a greater priority than the transmission.

10. The apparatus of claim 9, wherein the instructions are further executable by the one or more processors, individually or collectively, to cause the apparatus to determine the threshold power level in accordance with a power class parameter associated with a transmit chain of the UE and further in accordance with a second transmit power level associated with the second transmission.

11. The apparatus of claim 9, wherein the instructions are further executable by the one or more processors, individually or collectively, to cause the apparatus to determine the threshold power level in accordance with a power class parameter associated with a transmit chain of the UE, a second transmit power level associated with the second transmission, and a transmit power offset parameter associated with the CG configuration.

12. The apparatus of claim 1, wherein the multiple sub-bands are associated with a virtual cell.

13. A method of wireless communication performed by a user equipment (UE), the method comprising:
receiving a downlink message indicating a configured grant (CG) configuration; and
performing a transmission in accordance with the CG configuration and using multiple sub-bands including a first sub-band and a second sub-band that is distinct from the first sub-band, the first sub-band including a first set of frequency resources that is non-contiguous with a second set of frequency resources of the second sub-band.

14. The method of claim 13, wherein the first sub-band is associated with a first downlink and uplink (D/U) resource allocation for a plurality of time slots, wherein the second sub-band is associated with a second D/U resource allocation for the plurality of time slots, and wherein the second D/U resource allocation is different than the first D/U resource allocation.

15. The method of claim 14, further comprising:
selecting one or more first uplink resources from the first D/U resource allocation; and
selecting one or more second uplink resources from the second D/U resource allocation,
wherein the transmission is performed further in accordance with the one or more first uplink resources and the one or more second uplink resources.

16. The method of claim 13, wherein the transmission is performed using at least a first occasion associated with the first sub-band and using at least a second occasion associated with the second sub-band.

17. The method of claim 13, wherein at least one of the first sub-band or the second sub-band is associated with a particular period, and wherein, within the particular period, the first sub-band is associated with a first resource configuration and the second sub-band is associated with a second resource configuration different than the first configuration.

18. The method of claim 17, wherein the first resource configuration includes one of a frequency hopping configuration or a time repetition configuration, and wherein the second resource configuration includes the other of the frequency hopping configuration or the time repetition configuration.

19. The method of claim 13, wherein performing the transmission includes transmitting, via the first sub-band, a report associated with the second sub-band.

20. The method of claim 19, wherein the report indicates one or more of a measurement associated with the second sub-band, a medium access control (MAC) control element (MAC CE) associated with the second sub-band, or uplink control information (UCI) associated with the second sub-band.

21. The method of claim 13, further comprising:
in accordance with determining that a first transmit power level associated with a particular CG occasion associated with the transmission exceeds a threshold power level:
skipping a transmit opportunity of the transmission during the particular CG occasion; and
performing a second transmission during the particular CG occasion, the second transmission having a greater priority than the transmission.

22. The method of claim 21, wherein the threshold power level is determined in accordance with a power class parameter associated with a transmit chain of the UE and further in accordance with a second transmit power level associated with the second transmission.

23. The method of claim 21, wherein the threshold power level is determined in accordance with a power class parameter associated with a transmit chain of the UE, a second transmit power level associated with the second transmission, and a transmit power offset parameter associated with the CG configuration.

24. The method of claim 13, wherein the multiple sub-bands are associated with a virtual cell.

25. An apparatus for wireless communication by a network node, comprising:
one or more processors;
memory coupled with the one or more processors; and
instructions stored in the memory and executable by the one or more processors, individually or collectively, to cause the apparatus to:
transmit a downlink message indicating a configured grant (CG) configuration; and
receive a transmission in accordance with the CG configuration and using multiple sub-bands including a first sub-band and a second sub-band that is distinct from the first sub-band, the first sub-band including a first set of frequency resources that is non-contiguous with a second set of frequency resources of the second sub-band.

26. The apparatus of claim 25, wherein the instructions are further executable by the one or more processors, individually or collectively, to cause the apparatus to receive, in connection with the transmission and via the first sub-band, a report associated with the second sub-band.

27. The apparatus of claim 26, wherein the report indicates one or more of a measurement associated with the second sub-band, a medium access control (MAC) control element (MAC CE) associated with the second sub-band, or uplink control information (UCI) associated with the second sub-band.

28. A method of wireless communication performed by a network node, the method comprising:
transmitting a downlink message indicating a configured grant (CG) configuration; and
receiving a transmission in accordance with the CG configuration and using multiple sub-bands including a first sub-band and a second sub-band that is distinct from the first sub-band, the first sub-band including a first set of frequency resources that is non-contiguous with a second set of frequency resources of the second sub-band.

29. The method of claim 28, wherein receiving the transmission includes receiving, via the first sub-band, a report associated with the second sub-band.

30. The method of claim 29, wherein the report indicates one or more of a measurement associated with the second sub-band, a medium access control (MAC) control element (MAC CE) associated with the second sub-band, or uplink control information (UCI) associated with the second sub-band.
